(19) United States
(12) Patent Application Publication
(10) Pub. No.: US 2013/0279622 A1
(43) Pub. Date: Oct. 24, 2013

(54) METHOD AND SYSTEM OF REDUCING POWER SUPPLY NOISE DURING TRAINING OF HIGH SPEED COMMUNICATION LINKS

(71) Applicants: Venkatraman Iyer, Austin, TX (US); Santanu Chaudhuri, Mountain View, CA (US); Stephen S. Chang, Portland, OR (US)

(72) Inventors: Venkatraman Iyer, Austin, TX (US); Santanu Chaudhuri, Mountain View, CA (US); Stephen S. Chang, Portland, OR (US)

(21) Appl. No.: 13/976,680

(22) PCT Filed: Sep. 30, 2011
(86) PCT No.: PCT/US11/54270

§ 371 Date: Jun. 27, 2013

(51) Int. Cl. H04L 1/00

(52) U.S. Cl. CPC H04L 1/0009
USPC 375/285

(57) ABSTRACT

A method and system to reduce the power supply noise of a platform during the training of high speed communication links. In one embodiment of the invention, the device has logic to stagger a bit lock pattern for each of one or more communication links and scramble a training sequence for each of the one or more communication links. By doing so, it removes the need for anti-noise circuits and in turn, reduces the silicon area and power of the devices. Further, by having the logic in the physical layers to facilitate the training of the communication links, it eliminates the need to redesign the package of the devices to shift the resonant frequencies.

### FIELD OF THE INVENTION

This invention relates to communication links, and more specifically but not exclusively, to a method and system to reduce the effects of power supply noise during the training of high speed communication links.

### BACKGROUND DESCRIPTION

Devices or agents often communicate using one or more communication links or lanes at very high data rates. The communication links are configured during a training phase using bit lock patterns and training sequences that are transmitted simultaneously on all the lanes.

However, when the communication links are operating at high speed during the training phase, the repetition frequency of the patterns may cause one of the harmonics to match the package frequency and the resulting resonance could increase the power supply noise.

### BRIEF DESCRIPTION OF THE DRAWINGS

The features and advantages of embodiments of the invention will become apparent from the following detailed description of the subject matter in which:

FIG. 1 illustrates a block diagram of a platform in accordance with one embodiment of the invention;

FIG. 2 illustrates the architectural layers of two communicatively coupled devices in accordance with one embodiment of the invention;

FIG. 3 illustrates a state machine in accordance with one embodiment of the invention;

FIG. 4 illustrates a timing diagram of a training phase in accordance with one embodiment of the invention; and

FIG. 5 illustrates a system to implement the methods disclosed herein in accordance with one embodiment of the invention.

### DETAILED DESCRIPTION

Embodiments of the invention described herein are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference numerals have been repeated among the figures to indicate corresponding or analogous elements. Reference in the specification to “one embodiment” or “an embodiment” of the invention means that a particular feature, structure, or characteristic described in connection with the embodiment is included in at least one embodiment of the invention. Thus, the appearances of the phrase “in one embodiment” in various places throughout the specification are not necessarily all referring to the same embodiment.

Embodiments of the invention provide a method and system to reduce the power supply noise of a platform during the training of high speed communication links. A device in the platform uses communication links that include, but is not limited to, serial, parallel, half-duplex, and full-duplex communication links and the like. In one embodiment of the invention, the device has logic to stagger a bit lock pattern for each of one or more communication links and scramble a training sequence for each of the one or more communication links. In one embodiment of the invention, the scrambling of the training sequence is performed by a bit-wise XOR operation of the training sequence with a bitlock pattern.

The type of signals in the communication links include, but is not limited to, single-ended signals, low voltage differential signals (LVDS) and any other form of signals. The communication links are trained all at the same time in one embodiment of the invention. In another embodiment of the invention, the communication links are organized into one or more groups and the groups can be trained at the same time or at different times.

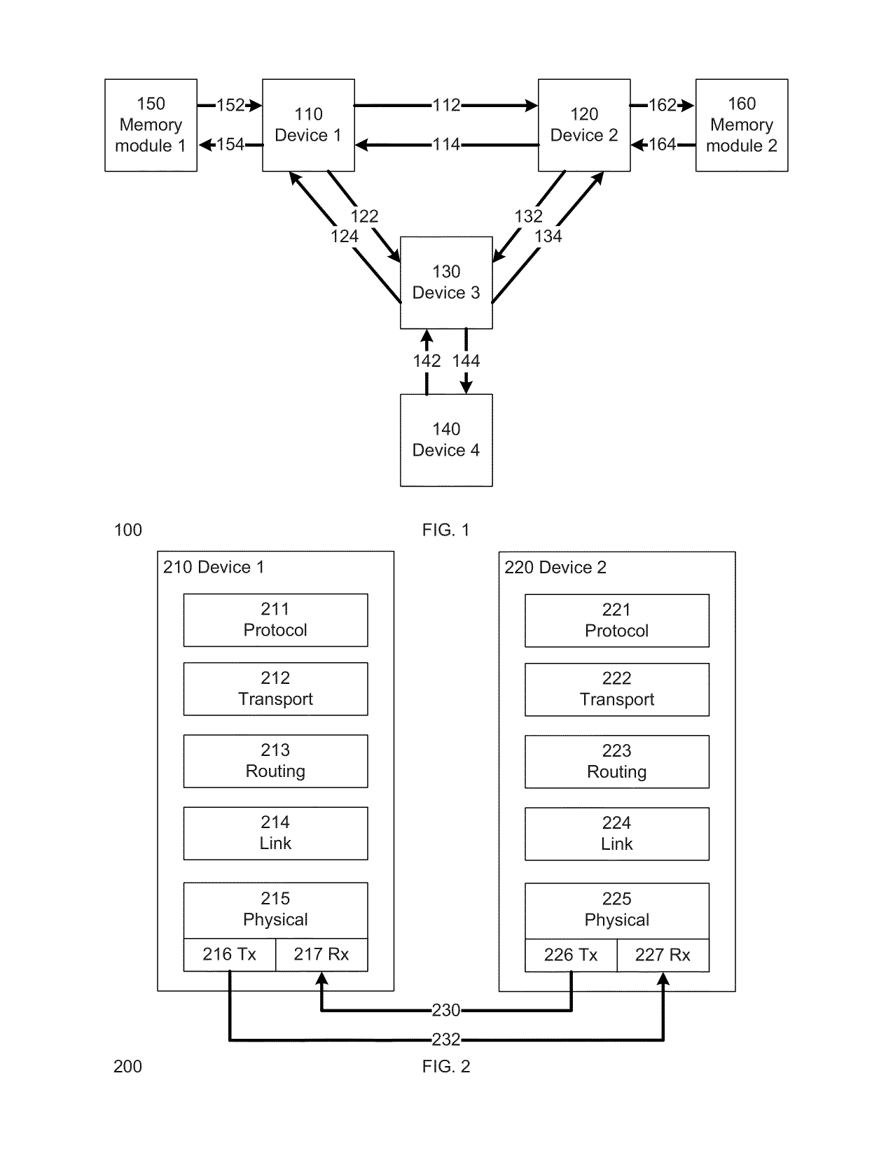

FIG. 1 illustrates a block diagram 100 of a platform in accordance with one embodiment of the invention. The platform includes, but is not limited to, a desktop computer, a laptop computer, a net book, a tablet computer, a notebook computer, a personal digital assistant (PDA), a server, a workstation, a cellular telephone, a mobile computing device, an Internet appliance or any other type of computing device.

The platform 100 has device 1 110, device 2 120, device 3 130, device 4 140, memory module 1 150 and memory module 2 160 in one embodiment of the invention. The device 1 110 is coupled with the device 2 120 via the two communication links or lanes 112 and 114. The device 1 110 sends information to the device 120 via the communication link 112 and receives information from the device 120 via the communication link 114. The device 1 110 is also coupled with the device 3 130 via the two communication links 122 and 124 and the device 2 120 is coupled with the device 3 130 via the two communication links 132 and 134. The device 3 130 is also coupled with the device 4 140 via the two communication links 142 and 144.

The device 1 110 is coupled with a memory module 1 150 in one embodiment of the invention via the two communication links 152 and 154. Similarly, the device 2 120 is coupled with a memory module 2 160 in one embodiment of the invention via the two communication links 162 and 164. The device 1 110 and device 2 120 has an integrated memory host controller to communicate with the memory module 1 150 and the memory module 2 160 respectively in one embodiment of the invention.

The communication links 112, 114, 122, 124, 132, 134, 142, 144, 152, 154, 162, and 164 include, but are not limited to, data signal channels, clock signal channels, control signal channels, address signals and the like. In one embodiment of the invention, the direction or flow of the communication links 112, 114, 122, 124, 132, 134, 142, 144, 152, 154, 162, and 164 is programmable or configurable. For example, in one embodiment of the invention, one or more channels of the communication link 112 can be programmed to flow from the device 2 120 to the device 1 110. Similarly, one or more channels of the communication link 114 can be programmed to flow from the device 1 110 to the device 2 120.

In one embodiment of the invention, each of the devices 1-4 110, 120, 130, and 140, and the memory module 1-2 150 and 160 has logic to reduce the power supply noise when training the communication links 112, 114, 122, 124, 132, 134, 142, 144, 152, 154, 162, and 164. For example, in one embodiment of the invention, during the training phase of the communication link 112, the device 1 110 has the ability to stagger the bit lock pattern for each of the one or more channels or lanes of the communication link 112 and scramble the training sequence for each of the one or more channels or lanes of the communication link 112. The device 1 110 may select one or more of the channels in the communication link 112 to be trained in one embodiment of the invention.

In one embodiment of the invention, the device 1 110 staggers the bit lock pattern for each of the one or more channels or lanes of the communication link 112 by sending rotated bit lock patterns on one or more channels or lanes of the communication link 112 during each unit interval (UI). The device 2 120 has logic to receive the staggered bit lock pattern for each of one or more channels or lanes of the communication link 112 and descramble the training sequence for each of one or more channels or lanes of the communication link 112.

The logic described for the device 1 110 and the device 2 120 is present in the device 3 130, the device 4 140 and the memory modules 1-2 150 and 160 in one embodiment of the invention. One of ordinary skill in the relevant will readily appreciate the workings of the logic in the device 3 130, the device 4 140 and the memory modules 1-2 150 and 160 and the training of the communication links 112, 114, 122, 124, 132, 134, 142, 144, 152, 154, 162, and 164 shall not be described herein.

In one embodiment of the invention, the communication links 112, 114, 122, 124, 132, 134, 142, 144, 152, 154, 162, and 164 operate at least in part with, but are not limited to, Intel® QuickPath Interconnect (QPI), Peripheral Component Interconnect (PCI) Express interface, Intel® Scalable Memory Interconnect (SMI) and the like. The devices 1-4 110, 120, 130, and 140 include, but are not limited to, processors, controllers, Input/Output (I/O) hubs, and the like. The memory modules 1-2 150 and 160 include, but are not limited to, a buffered memory module, and the like.

The configuration of the platform 100 serves as an illustration of one embodiment of the invention and is not meant to be limiting. One of ordinary skill in the relevant art will readily appreciate that other configurations of the platform 100 can be used without affecting the workings of the invention and the other configurations shall not be described herein. For example, in one embodiment of the invention, the platform 100 has one or more peripheral logic modules.

FIG. 2 illustrates the architectural layers 200 of two communicatively coupled devices or agents in accordance with one embodiment of the invention. For clarity of illustration, the architectural layers 200 are compliant at least in part with the Intel® QPI in one embodiment of the invention. The device 1 210 has a protocol layer 211, a transport layer 212, a routing layer 213, a link layer 214, and a physical layer 215. The device 2 220 similarly has a protocol layer 221, a transport layer 222, a routing layer 223, a link layer 224, and a physical layer 225. The device 1 210 sends information via the transmission (TX) logic 216 in the physical layer 215 to the receive (RX) logic 227 in the physical layer 225 of the device 2 220.

In one embodiment of the invention, the device 1 210 and the device 2 220 have logic in the physical layers 215 and 225 to facilitate the training of the communication links 230 and 232 that allows reduction of the power supply noise. This removes the need for anti-noise circuits and in turn, reduces the silicon area and power of the devices. Further, by having the logic in the physical layers 215 and 225 to facilitate the training of the communication links 230 and 232, it eliminates the need to redesign the package of the devices to shift the resonant frequencies.

The communication links 230 and 232 between the physical layers 215 and 225 are wired in one embodiment of the invention. The wiring includes, but is not limited to, interconnect cables or wires, printed circuit board (PCB) electrical traces and the like. The communication links 230 and 232 may mean physically different connections (i.e. unidirectional connections between the TX logic and the RX logic) or same connection (i.e. bi-directional connections between the TX logic and the RX logic), where the role of the TX logic and the RX logic alternates between the two ends.

The link layers 214 and 224 ensure reliable transmission and flow control of information between the device 1 210 and the device 2 220 in one embodiment of the invention. In one embodiment of the invention, the link layers 214 and 224 have logic to implement a synchronizing mechanism between the device 1 210 and the device 2 220. The routing layers 213 and 223 provide the framework for directing packets through the fabric in one embodiment of the invention. The transport layers 212 and 222 provide advanced routing capability including, but is not limited to, end-to-end transmission of data.

The protocol layers 211 and 221 have a high-level set of rules for exchanging data packets between the device 1 210 and the device 2 220 in one embodiment of the invention. The architectural layers 200 illustrated in FIG. 2 in not meant to be limiting and one of ordinary skill in the relevant art will readily appreciate that other configuration of the architectural layers 200 can be used without affecting the workings of the invention. For example, in one embodiment of the invention, devices on either side of the communication link can have any layer arrangement as long as either one is equipped to send and receive appropriate patterns from the other. In another embodiment of the invention, the transport layers 212 and 224 are not part of the architectural layers 200. When the device 1 210 and the device 2 220 use another communication protocol, one of ordinary skill in the relevant art will also readily appreciate that how to modify the architectural layers of the other communication protocol based at least in part on the architectural layers 200 and the modifications shall not be described herein.

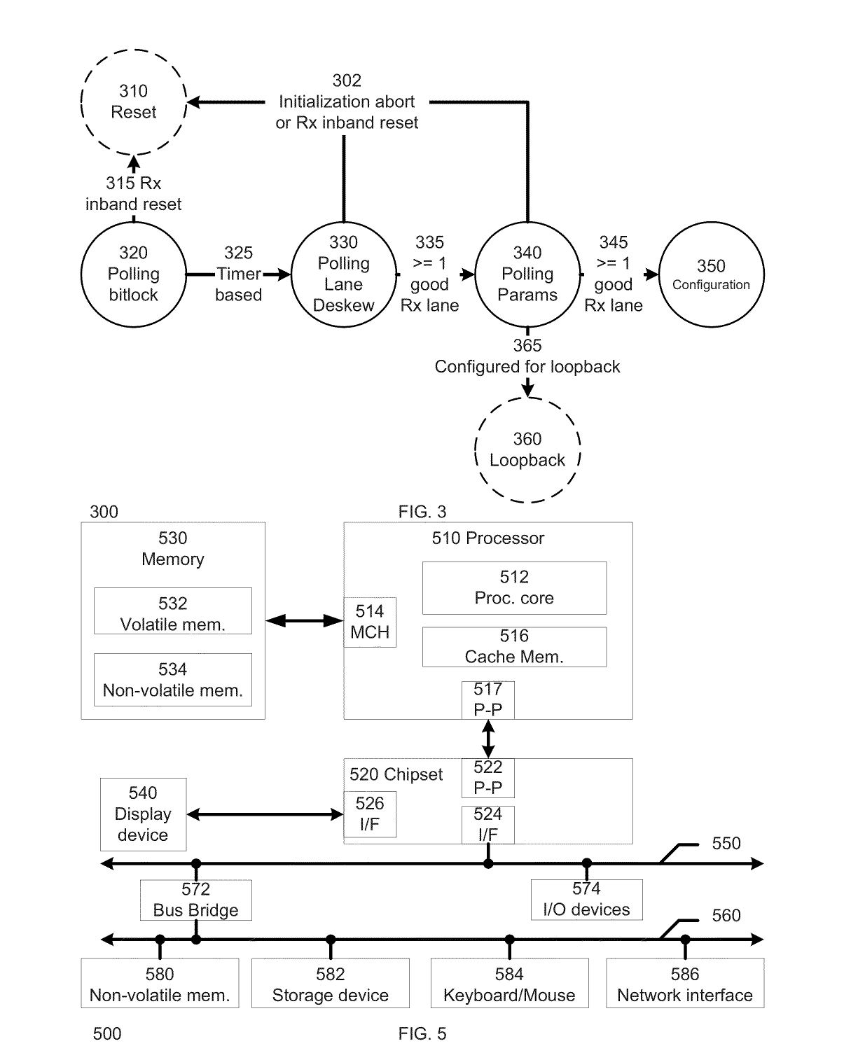

FIG. 3 illustrates a state machine 300 in accordance with one embodiment of the invention. For clarity of illustration, FIG. 3 is discussed with reference to FIGS. 1 and 2. FIG. 3 illustrates the states during the training phase of the transmitting device and/or the receiving device in one embodiment of the invention. There may be other states in the state machine 300 that are not shown in FIG. 3 for clarity of illustration.

In one embodiment of the invention, the state machine 300 is implemented in the physical layers 215 and 225. In another embodiment of the invention, the state machine 300 is implemented in the links layers 214 and 224. In yet another embodiment of the invention, the state machine 300 is implemented in firmware or software or any combination thereof in the device 1 210 and the device 2 220. One of ordinary skill in the relevant art will readily appreciate that the state machine 300 can be implemented in any configuration or form in the devices or the platform without affecting the workings of the invention.

In one embodiment of the invention, a transmitting device and a receiving device in the platform 100 have logic to operate in accordance with the state machine 300. The state machine 300 facilitates the training of the communication links 230 and 232 that allows reduction of the power supply noise. The state machine 300 has a reset state 310, a polling bit lock state 320, a polling lane deskew state 320, a polling parameters (Params) state 340, a configuration state 350 and a loop back state 360 in one embodiment of the invention. FIG. 3 illustrates the states during the training phase of the transmitting device and/or the receiving device in one embodiment of the invention.

In the optional reset state 310, a device enters a reset mode and all settings are set to their default or initial values. In one embodiment of the invention, the default or initial values of the settings of the device are programmable. For example, in one embodiment of the invention, the default settings of the device can be programmed by changing the values of the register(s) that stores the default settings of the device.

The device enters the polling bit lock state 320 when it is in the training or retraining phase. In one embodiment of the invention, the transmitting device staggers the bit lock pattern for each of the one or more channels or lanes of the communication link with the receiving device by sending rotated bit lock patterns on one or more channels or lanes of the communication link during each unit interval (UI). In one embodiment of the invention, the transmitting device scrambles the training sequences for each of the one or more channels or lanes of the communication link with the receiving device. The receiving device receives the staggered bit lock pattern for each of one or more channels or lanes of the communication link with the transmitting device and descrambles the training sequence for each of one or more channels or lanes of the communication link in one embodiment of the invention.

When the device receives a receive (Rx) inband reset 315 request, the device transitions from the polling bit lock state 320 to the reset state 310. In one embodiment of the invention, the device transitions from the polling bit lock state 320 to the polling lane deskew state 330 based on a timer or counter. In the polling lane deskew state 330, the receiving device performs the deskewing of the communication link with the transmitting device. When the device receives an initialization abort request or the Rx inband reset request 302, the device transitions from the polling lane deskew state 330 to the reset state 310.

The device transitions from the polling lane deskew state 330 to the polling parameters state 340 when there is at least one good receive lane or link 335. In the polling parameters state 340, the device obtains the relevant parameters to configure the communication link. The parameter include, but is not limited to, rate of data transfer, transmission power, receiver sensitivity, and other parameter required to configure the communication link. When the device receives an initialization abort request or the Rx inband reset request 302, the device transitions from the polling parameters state 340 to the reset state 310.

In one embodiment of the invention, the devices can be configured for loopback by transitioning from the polling parameters state 340 to the optional loopback state 360. In loopback, one side acts as the master to send the scrambled training sequences while the other side acts as the slave to loop it back at any bit boundary. This is a simple way to re-sync the loopback headers at the master in one embodiment of the invention. In one embodiment of the invention, the slave device checks or verifies the pattern in addition to looping it back. After the devices have finished polling the parameters, the devices transition from the polling parameters state 340 to the configuration state 350. In the configuration state 350, the devices are configured with the parameters in one embodiment of the invention.

The state machine 300 is not meant to be limiting and other configurations of the state machine 300 can be used without affecting the workings of the invention. For example, in another embodiment of the invention, more states can be added to the state machine 300 as required. In another embodiment of the invention, some states can be combined.

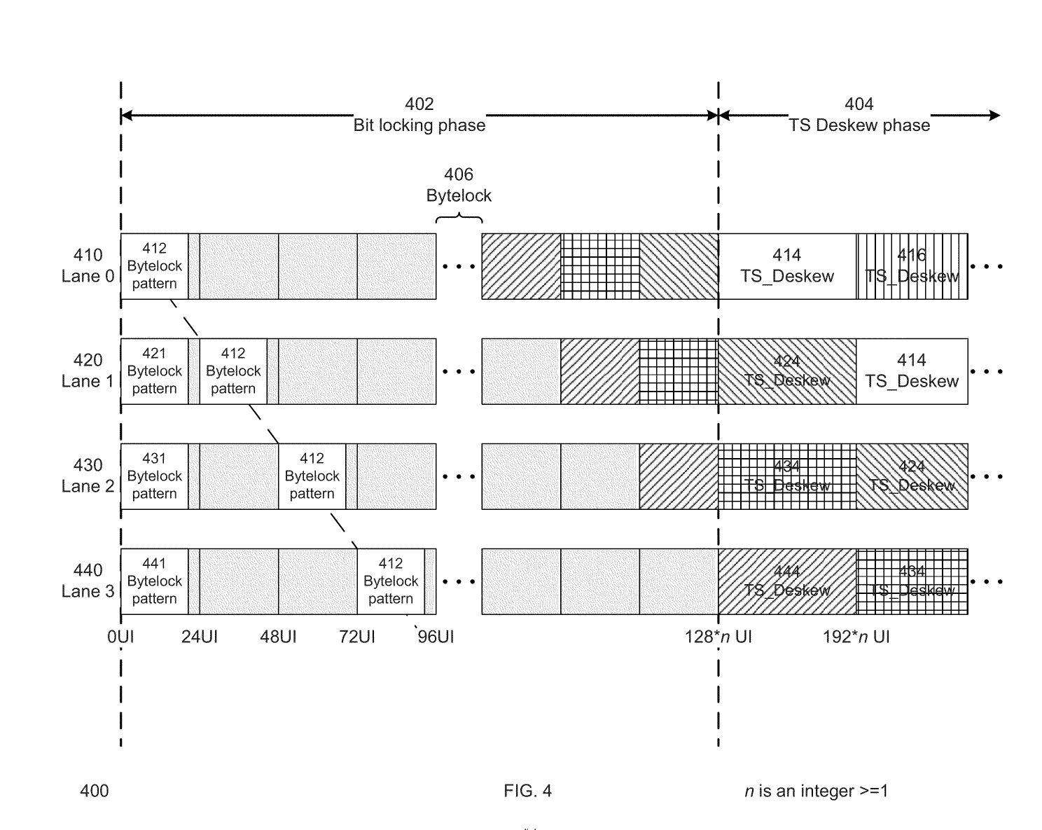

FIG. 4 illustrates a timing diagram 400 of a training phase in accordance with one embodiment of the invention. For clarity of illustration, four communication links or lanes 0 410, 1 420, 2 430 and 3 410 are illustrated. In other embodiments of the invention, there may be more than four or less than four communication lanes.

In one embodiment of the invention, the training phase has a bit locking phase 402 and a training sequence (TS) deskew phase 404. In the bit locking phase 402, the transmitting device sends a byte lock pattern 412 that is staggered among the communication lanes 0 410, 1 420, 2 430 and 3 410. The byte lock pattern 412 is a known or pre-determined sequence in one embodiment of the invention. For example, in one embodiment of the invention, the byte lock pattern 412 is a PRBS sequence that is created using a seed. One of ordinary skill in the relevant art will readily appreciate how to generate a PRBS sequence and it shall not be described herein.

To create the same byte lock pattern 412 for each of the communication lanes 0 410, 1 420, 2 430 and 3 410, the same seed is used for creating the PRBS sequence as the byte lock pattern 412 in one embodiment of the invention. The transmitting device ensures that the byte lock pattern 412 is transmitted on only one of the communication lanes 0 410, 1 420, 2 430 and 3 410 during each user interval (UI). For example, in one embodiment of the invention, during the interval from 0 UI to 24 UI, the byte lock pattern 412 is only transmitted on the communication lane 0 410. This allows for the same logic to be shared among the lanes in one embodiment of the invention.

The communication lanes 1 420, 2 430 and 3 410 may transmit the byte lock patterns 421, 431 and 441 respectively. During the interval from 24 UI to 48 UI, the byte lock pattern 412 is only transmitted on the communication lane 1 420. During the interval from 48 UI to 72 UI, the byte lock pattern 412 is only transmitted on the communication lane 2 430. During the interval from 72 UI to 96 UI, the byte lock pattern 412 is only transmitted on the communication lane 3 440.

The byte lock 406 illustrates the time needed by the receiving device to obtain bit locking. After the byte locking by the receiving device, the transmitting device sends the scrambled training sequence in one embodiment of the invention. The deskew training sequences (TS_Deskew) 414, 416, 424, 434, 444, and illustrate the scrambled training sequences in one embodiment of the invention.

FIG. 5 illustrates a system 500 to implement the methods disclosed herein in accordance with one embodiment of the invention. The system 500 includes, but is not limited to, a desktop computer, a laptop computer, a net book, a notebook computer, a personal digital assistant (PDA), a server, a workstation, a cellular telephone, a mobile computing device, an Internet appliance or any other type of computing device. In another embodiment, the system 500 used to implement the methods disclosed herein may be a system on a chip (SOC) system or system in package (SIP) system.

The processor 510 has a processing core 512 to execute instructions of the system 500. The processing core 512 includes, but is not limited to, pre-fetch logic to fetch instructions, decode logic to decode the instructions, execution logic to execute instructions and the like. The processor 510 has a cache memory 516 to cache instructions and/or data of the system 500. In another embodiment of the invention, the cache memory 516 includes, but is not limited to, level one, level two and level three, cache memory or any other configuration of the cache memory within the processor 510.

The memory control hub (MCH) 514 performs functions that enable the processor 510 to access and communicate with a memory 530 that includes a volatile memory 532 and/or a non-volatile memory 534. The volatile memory 532 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 534 includes, but is not limited to, NAND flash memory, phase change memory (PCM), read only memory (ROM), electrically erasable programmable read only memory (EEPROM), or any other type of non-volatile memory device.

The memory 530 stores information and instructions to be executed by the processor 510. The memory 530 may also stores temporary variables or other intermediate information while the processor 510 is executing instructions. The chipset 520 connects with the processor 510 via Point-to-Point (PtP) interfaces 517 and 522. The chipset 520 enables the processor 510 to connect to other modules in the system 500. In one embodiment of the invention, the interfaces 517 and 522 operate in accordance with a PtP communication protocol such as the Intel® QuickPath Interconnect (QPI) or the like. The chipset 520 connects to a display device 540 that includes, but is not limited to, liquid crystal display (LCD), cathode ray tube (CRT) display, or any other form of visual display device.

In addition, the chipset 520 connects to one or more buses 550 and 560 that interconnect the various modules 574, 580, 582, 584, and 586. Buses 550 and 560 may be interconnected together via a bus bridge 572 if there is a mismatch in bus speed or communication protocol. The chipset 520 couples with, but is not limited to, a non-volatile memory 580, a mass storage device(s) 582, a keyboard/mouse 584 and a network interface 586. The mass storage device 582 includes, but is not limited to, a solid state drive, a hard disk drive, an universal serial bus flash memory drive, or any other form of computer data storage medium. The network interface 586 is implemented using any type of well known network interface standard including, but not limited to, an Ethernet interface, a universal serial bus (USB) interface, a Peripheral Component Interconnect (PCI) Express interface, a wireless interface and/or any other suitable type of interface. The wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 5 are depicted as separate blocks within the system 500, the functions performed by some of these blocks may be integrated within a single semiconductor circuit or may be implemented using two or more separate integrated circuits. For example, although the cache memory 516 is depicted as a separate block within the processor 510, the cache memory 516 can be incorporated into the processor core 512 respectively. The system 500 may include more than one processor/processing core in another embodiment of the invention.

The methods disclosed herein can be implemented in hardware, software, firmware, or any other combination thereof. Although examples of the embodiments of the disclosed subject matter are described, one of ordinary skill in the relevant art will readily appreciate that many other methods of implementing the disclosed subject matter may alternatively be used. In the preceding description, various aspects of the disclosed subject matter have been described. For purposes of explanation, specific numbers, systems and configurations were set forth in order to provide a thorough understanding of the subject matter. However, it is apparent to one skilled in the relevant art having the benefit of this disclosure that the subject matter may be practiced without the specific details. In other instances, well-known features, components, or modules were omitted, simplified, combined, or split in order not to obscure the disclosed subject matter.

The term “is operable” used herein means that the device, system, protocol etc, is able to operate or is adapted to operate for its desired functionality when the device or system is in off-powered state. Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

The techniques shown in the figures can be implemented using code and data stored and executed on one or more computing devices such as general purpose computers or computing devices. Such computing devices store and communicate (internally and with other computing devices over a network) code and data using machine-readable media, such as machine readable storage media (e.g., magnetic disks; optical disks; random access memory; read only memory; flash memory devices; phase-change memory) and machine readable communication media (e.g., electrical, optical, acoustical or other form of propagated signals—such as carrier waves, infrared signals, digital signals, etc.).

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. An apparatus comprising:
logic to:
stagger a bit lock pattern for each of one or more communication links; and
scramble a training sequence for each of the one or more communication links.

2. The apparatus of claim 1, wherein the logic to stagger the bit lock pattern for each of the one or more communication links is to:
send the bit lock pattern on only one of the one or more communication links during each unit interval (UI).

3. The apparatus of claim 1, wherein the bit lock pattern is a pseudo random binary sequence (PBRS) with a known seed, and wherein the logic to scramble the training sequence for each of the one or more communication links is to perform a bit-wise XOR operation of the training sequence with the staggered bit lock pattern.

4. The apparatus of claim 1, wherein the training sequence is a deskew training sequence.

5. The apparatus of claim 1, wherein the one or more communication links operate in accordance with one of QuickPath Interconnect (QPI), Peripheral Component Interconnect Express (PCIe), and Scalable Memory Interconnect (SMI).

6. The apparatus of claim 1, wherein the one or more communication links comprises one of a serial, parallel, half-duplex, and full-duplex communication links.

7. The apparatus of claim 1, wherein the apparatus is a master device in a loopback mode, and wherein the logic is further to:
re-deskew received scrambled training sequences looped back at any unit interval (UI) boundary.

8. An apparatus comprising:
logic to:
receive a staggered bit lock pattern for each of one or more communication links; and
descramble a training sequence for each of the one or more communication links.

9. The apparatus of claim 8, wherein the logic to receive the staggered bit lock pattern for each of the one or more communication links is to receive the staggered bit lock pattern for each of the one or more communication links during a training of the one or more communication links.

10. The apparatus of claim 8, wherein the logic to receive the staggered bit lock pattern for each of the one or more communication links is to receive the bit lock pattern on only one of the one or more communication links during each unit interval (UI).

11. The apparatus of claim 8, wherein the bit lock pattern is a pseudo random binary sequence (PBRS) with a known seed.

12. The apparatus of claim 8, wherein the training sequence is a deskew training sequence.

13. The apparatus of claim 8, wherein the one or more communication links operate in accordance with one of QuickPath Interconnect (QPI), Peripheral Component Interconnect Express (PCIe), and Scalable Memory Interconnect (SMI).

14. The apparatus of claim 8, wherein the one or more communication links comprises one of a serial, parallel, half-duplex, and full-duplex communication links.

15. The apparatus of claim 8, wherein the apparatus is a slave device in a loopback mode, and wherein the logic is further to check whether received scrambled training sequences are received correctly.

16. The apparatus of claim 8, wherein the apparatus is a slave device in a loopback mode, and wherein the logic is further to loopback the received scrambled training sequences at any unit interval (UI) boundary on each of the one or more communication links.

17. A method comprising:
staggering a bit lock pattern for each of one or more communication links; and
scrambling a training sequence for each of the one or more communication links.

18. The method of claim 17, wherein staggering the bit lock pattern for each of the one or more communication links comprises:
sending the bit lock pattern on only one of the one or more communication links during each unit interval (UI).

19. The method of claim 17, wherein the bit lock pattern is a pseudo random binary sequence (PBRS) with a known seed, and wherein scrambling the training sequence for each of the one or more communication links comprises performing a bit-wise XOR operation of the training sequence with the staggered bit lock pattern.

20. The method of claim 17, wherein the training sequence is a deskew training sequence.

21. The method of claim 17, wherein the one or more communication links operate in accordance with one of QuickPath Interconnect (QPI), Peripheral Component Interconnect Express (PCIe), and Scalable Memory Interconnect (SMI).

22. The method of claim 17, further comprising:
re-deskewing received scrambled training sequences looped back at any unit interval (UI) boundary.

23. A method comprising:
receiving a staggered bit lock pattern for each of one or more communication links; and
descrambling a training sequence for each of the one or more communication links.

24. The method of claim 23, wherein receiving the staggered bit lock pattern for each of the one or more communication links comprises:
receiving the staggered bit lock pattern for each of the one or more communication links during a training of the one or more communication links.

25. The method of claim 23, wherein receiving the staggered bit lock pattern for each of the one or more communication links comprises:
receiving the bit lock pattern on only one of the one or more communication links during each unit interval (UI).

26. The method of claim 23, wherein the bit lock pattern is a pseudo random binary sequence (PBRS) with a known seed.

27. The method of claim 23, wherein the training sequence is a deskew training sequence.

28. The method of claim 23, wherein the one or more communication links operate in accordance with one of QuickPath Interconnect (QPI), Peripheral Component Interconnect Express (PCIe), and Scalable Memory Interconnect (SMI).

29. The method of claim 23, further comprising checking whether received scrambled training sequences are received correctly.

30. The method of claim 23, further comprising checking looping back the received scrambled training sequences at any unit interval (UI) boundary on each of the one or more communication links.
